(19) United States
(12) Patent Application Publication
(10) Pub. No.: US 2005/0069191 A1
(43) Pub. Date: Mar. 31, 2005

(54) Method and apparatus for generating a robust reference image of a container and for selecting of a container

(76) Inventors: Dan Van Der Meer, Delft (NL); Jensen Peter Akkerman, Huizen (NL); Sjoerd Van Der Zwaan, Sn Bussum (NL); Arend Van De Stadt, Huizen (NL); Frederik Nico Endtz, Rotterdam (NL); Bernardus Cornelis Johannes Landman, Wr Boskoop (NL)

Correspondence Address: OSTROLENK FABER GERB & SOFFEN, 1180 AVENUE OF THE AMERICAS, NEW YORK, NY, 100368403, US

(21) Appl. No.: 10/495,921

(22) PCT Filed: Nov. 18, 2002
(86) PCT No.: PCT/NL02/00750

(30) Foreign Application Priority Data
Nov. 16, 2001 (NL) 1019381

(51) Int. Cl. G06K 9/00

(52) U.S. Cl. 382/142

(57) ABSTRACT

The present invention provides a method for composing a robust reference image or reference image with permissible deviation values of the exterior of a series of practically identical containers, such as bottles, crates and the like, comprising steps for: a) making an image recording of a part of the exterior of a plurality of containers from the series; b) processing the recorded image in order to obtain a first representation; c) composing a complete peripheral view of the exterior of the container on the basis of the first representations; d) determining, on the basis of all recorded images and parameters to be preset, the robust reference image of the container on the basis of which acceptable differences can be taken into account during selection of containers.

The present invention relates to systems for selecting containers, comprising steps for detecting aberrations in the exterior of the container. Such systems are important since, in the market for containers such as for instance bottles or crates, such containers with a modern appearance impart a commercial added value to the products supplied therein. Damage or imperfections on such containers will however detract greatly from the high perceived value of the products.

Containers with a damaged exterior greatly impair the image of the product for the modern consumer. In order to prevent such impairment, it is important that the containers are properly inspected.

In order to enable such an inspection, the present invention provides a method for composing a robust reference image, or a reference image with permissible deviation values of the exterior of a series of practically identical containers, such as bottles, crates and the like, comprising steps for:
making an image recording of a part of the exterior of a plurality of containers from the series,
processing the recorded image in order to obtain a first representation,
composing a complete peripheral view of the exterior of the container on the basis of the first representations,
determining, on the basis of all recorded images and parameters to be preset, the robust reference image or reference image on the basis of which acceptable differences can be taken into account during selection of containers.

Such a robust reference image is preferably obtained by determining, preferably per pixel, a mean value of the image and a mean deviation (standard deviation) thereof; the robust reference image then consists of two parts. It is preferably built up by starting with an image, whereafter subsequent images are automatically added thereto until, for instance after 1000 bottles, the robust reference image is complete. This can hereby take place during normal use of the installation, while the images of bottles in different positions show coherence.

Such a robust reference image, or a reference image with permissible deviation values, is important since printed bottles for instance differ slightly from each other due to for instance the production method. Printed or adhered labels can for instance be shifted somewhat in height or be printed in slightly deformed manner. Such deviations are however no reason for rejection. An apparatus which would not take into account such deviations would however select bottles for rejection if such deviations are observed. According to the present invention a robust reference image, or a reference image with permissible deviation values, is therefore composed in which acceptable deviations are taken into account. Such deviations may comprise damage, size, features or colour differences.

An example of such a method is that a reference image can be formed on the basis of data obtained on the basis of the containers used in practice. In order to manufacture the robust reference image, image recordings are made of for instance at least a thousand containers. Such a quantity gives sufficient deviation information for approving the normally occurring, acceptable deviations during a selection process of containers.

The above described method for composing a robust reference image or reference image with permissible deviation values for the exterior of a series of practically identical containers preferably comprises steps for applying statistical analysis methods in determining the robust reference image. Using such steps it is possible to use standard deviations, or for instance to apply factors to such standard deviations in order to obtain an optimal ratio between acceptance and rejection of containers in a selective process. Such an optimal ratio can for instance be determined on the basis of the cost of the containers in relation to a market value assessment based on the value of high-quality containers as perceived by consumers.

A further aspect of the present invention relates to a method for selecting a container, such as a crate or bottle and the like, comprising steps for detecting deviations on the exterior of the container, comprising steps for:
making an image recording of a part of the exterior,
processing the recorded image in order to obtain a second representation,
comparing the second representation to a robust reference image.

Processing of the recorded image preferably comprises steps for transforming an aspect view of a curved surface to a faithful flat rendition. Using a method according to such a preferred embodiment, the exterior of a container, such as for instance a label arranged thereon or a printing applied thereto, can be compared to the robust reference image or the reference image with the permissible deviation values of the exterior of a series of practically identical containers.

Image recordings are herein made of a part of the side wall of for instance round containers. In practice a readily processable recording is made of for instance 60° of the periphery. A wider recording of for instance 120° is also possible. The theoretically feasible recording of 180° however produces in practice less useful results close to the edges. In the case of a container with straight walls such as a square or rectangular container, recordings are made of a whole side wall.

In the case of a round container such as a bottle, the robust reference image comprises a faithful flat rendition of the whole side wall over 360°. The recording of for instance 60° which is made in the present embodiment, is fitted onto the corresponding part of the robust reference image after being processed to a faithful flat rendition. A comparison is then made as to whether the similarities fall within the set limit values of the robust reference image, which results in approval of this part-image and thereby the bottle, or that the present image falls outside the tolerances of the robust reference image, which results in rejection of the present bottle.

In a further embodiment use is made of the second representation to compose the robust reference image. This embodiment has the advantage that in the reference image, or in the deviation values included therein, account is taken of data of containers of which recordings are made during the method for selection. During the selection process, the robust reference image is hereby more and more adapted to a series of deviation values to be detected. In statistical terms this means that the sample size on the basis of which deviation values are determined becomes increasingly larger.

In order to obtain a sufficiently high speed (for instance 16 bottles/sec), use is preferably made of a coarse and a fine fitting.

Approval or rejection preferably takes place using distinguishable, parameterized differential measurements, such as colour difference, shape difference (non-roundness and the like) and so on.

The parameters preferably comprise data relating to the container, threshold values relating to colour differences or formats of printing and the like. It is important for the appearance of the container that for instance a printing is placed somewhat at the correct height; variations in the height of the printing will however, within limits, detract little from the appreciation of a container by an end user. Variations therein are therefore allowed. Too rigid an assessment of the height of the printing would therefore result in undesirable rejection. Such undesirable rejection is prevented by taking this into account using this method. The same sort of reasoning applies in relation to for instance colour differences or differences in printing format. Small aberrations herein can occur in large series of containers. By taking account of data relating to large quantities of containers of a series, undesirable rejection, which involves high costs, is prevented.

In order to be able to work in simple manner with containers from different series, a preferred embodiment of the method comprises the possibility of composing profiles comprising the above described data for the purpose of carrying out selections on mutually alternating series of containers matching respective profiles. If such a method is performed using an apparatus for selecting the containers, it is recommended to process different series of containers in efficient manner using one apparatus. These profiles enable simple switching of series, wherein the correct selections are made by applying the profile matching the series.

In a further preferred embodiment the container is illuminated while the recording is made. This has the advantage for instance that a usable recording can be made by applying sufficient light. By applying light of the same intensity and colour in different recordings, it is further possible to make recordings wherein data relating to the colour of the exterior of the container, such as a printing, is kept constant, whereby the forming of a robust reference image or the assessment on the basis of colour aspects of the exterior of the container can be performed with constant quality.

The container is preferably a bottle or a crate. Such containers as bottles or crates are very important in a distribution channel for the value perceived by consumers.

In the preferred embodiment the processing speed of the containers is higher than ten containers per second, preferably higher than sixteen containers per second. A high processing speed is important for the manufacturers of products sold in the containers. In practice it is very practical to carry out the method subsequent to filling of containers. Such containers, such as bottles, are filled in a filling line. The method for selecting and building up the robust reference image must then be performed at the same speed as the filling of the bottles. In practice, this speed is becoming increasingly higher.

Particularly in the case of bottles, use is preferably made of skimming light on the top and bottom, wherein the background remains as dark as possible.

A further aspect of the present invention relates to an apparatus for selecting containers, comprising:
recording means for making at least one recording of part of a side of the container directed toward the recording means,
processing means for processing a recorded image in order to obtain a first or second representation,
transmitting means for transmitting recording data to the processing means,
comparing means for comparing the second representation to a robust reference image obtained on the basis of parameters to be preset and data from first or second representations.

Such an apparatus preferably further comprises composing means for composing, on the basis of first and second representations and/or predetermined parameters, a robust reference image or a reference image with permissible deviation values, on the basis of which image acceptable and/or natural differences between individual containers within a series of containers can be taken into account during selection of containers. Such apparatus embodiments are able to perform an above described method and have at least the above described advantages.

Such an apparatus preferably further comprises ejecting means for ejecting selected containers. Selected containers are in this respect containers which do not conform to the robust reference image, or the reference image with permissible deviation values.

The use of illuminating means and screening means while making the recording increases the quality of the recording.

In the further preferred embodiment the apparatus comprises actuating means for actuating making of a recording when a container is correctly positioned relative to the recording means. An advantage hereof is that a recording is made which is centred as accurately as possible relative to the container. A further advantage is that it is possible to keep track of which container is being assessed.

The apparatus preferably comprises rotating means for rotating the container between the making of two successive recordings. Such an embodiment enables making of a plurality of recordings of one container, whereby on the basis of complete information relating to the exterior of the container it is possible to assess whether it falls within the correct tolerances.

A significant advantage of the present invention relates to the possibility, using differential images, of detecting contaminants such as cigarette ends and the like in bottles with printed, i.e. partly transparent, labels, since the image information of the labels can be filtered out.

Further advantages, features and details of the present invention will be elucidated on the basis of the following description of preferred embodiments thereof with reference to the annexed figures, in which:

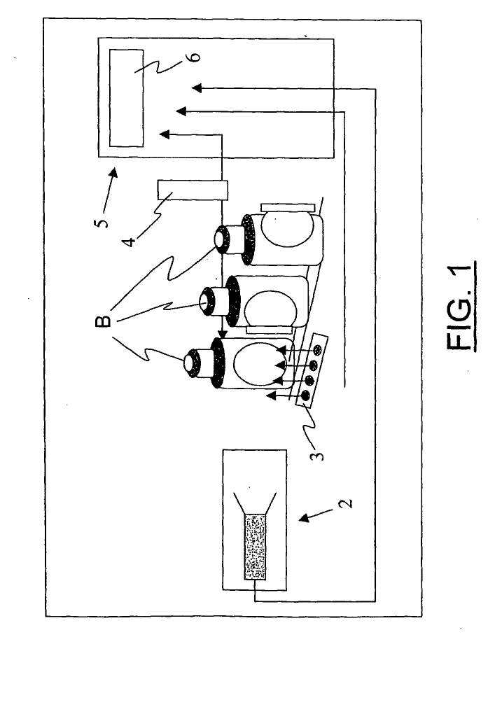

FIG. 1 is a schematic side view of an apparatus for selecting a container;

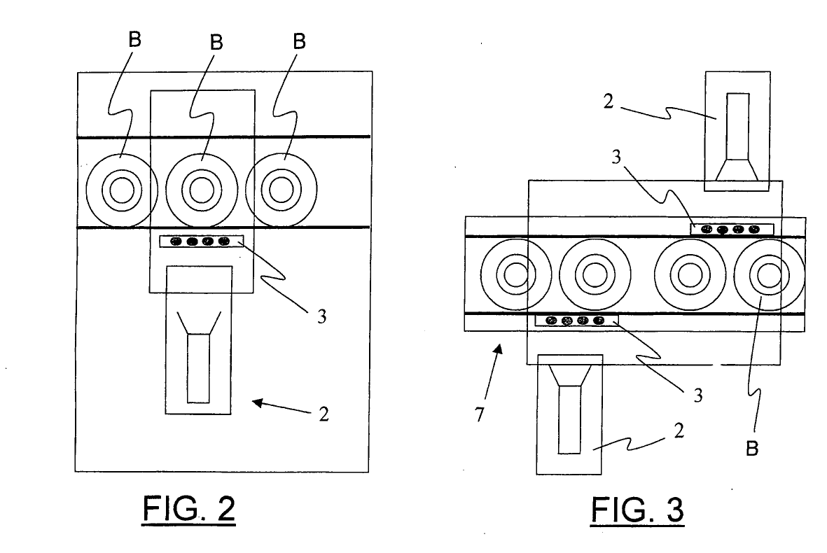

FIG. 2 is a top view of an apparatus as shown in FIG. 1;

FIG. 3 is a top view of a further embodiment;

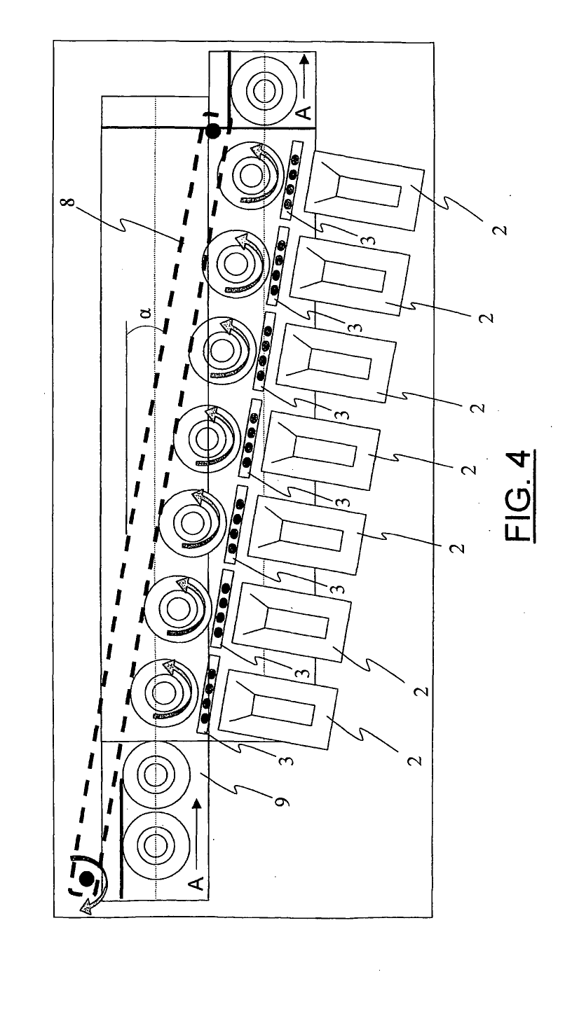

FIG. 4 is a top view of a further embodiment;

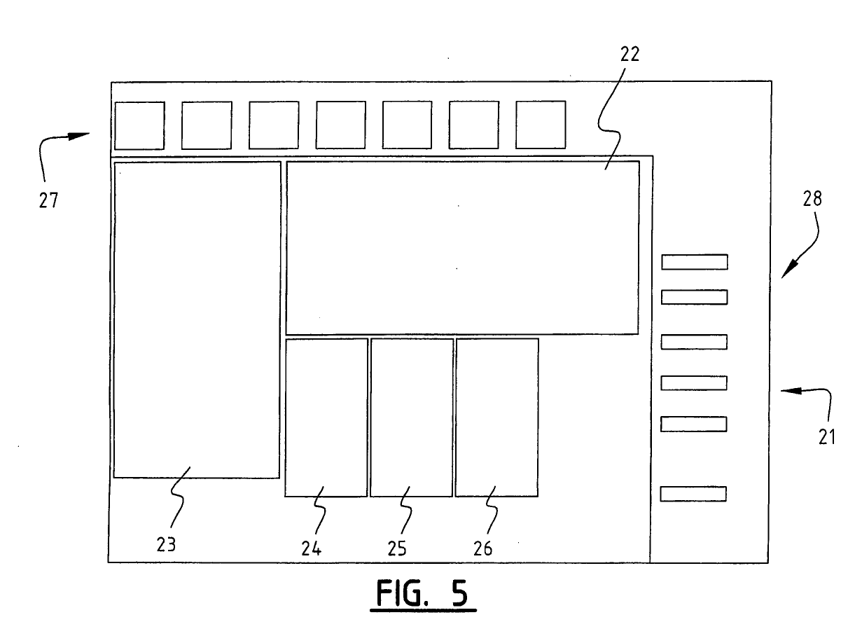

FIG. 5 is a schematic view of a representation of a computer screen;

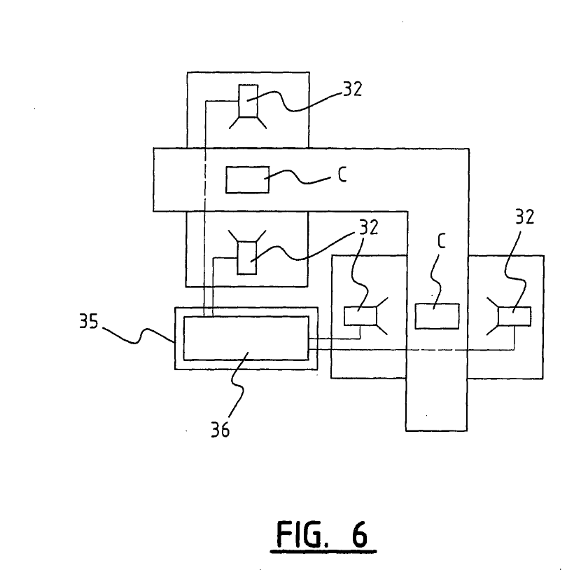

FIG. 6 is a top view of a further embodiment;

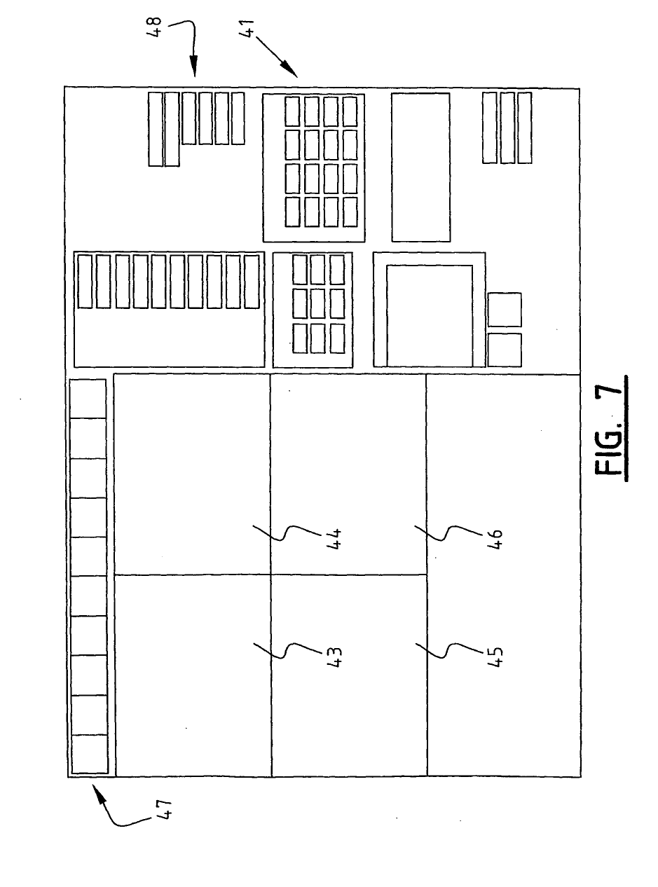

FIG. 7 is a schematic view of a computer screen;

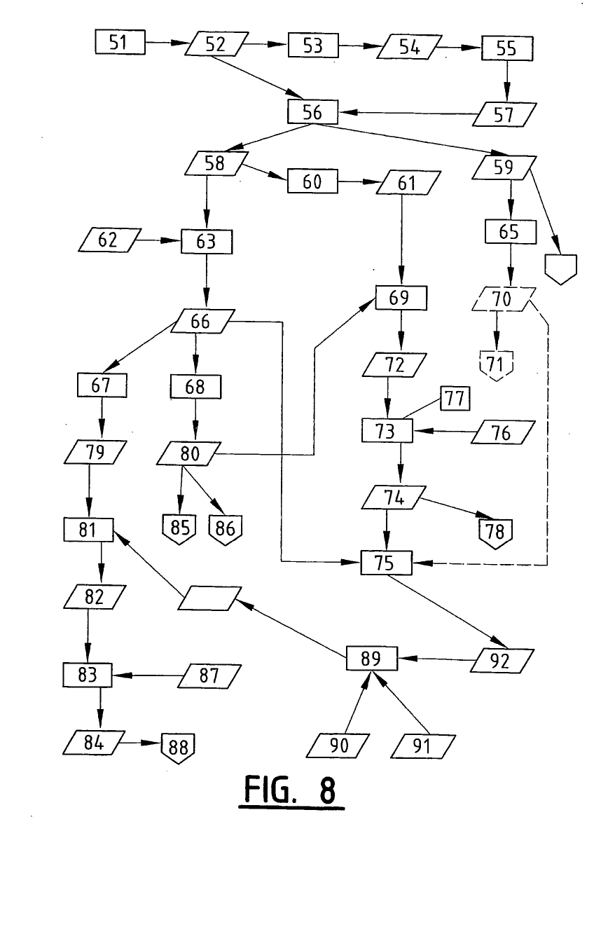

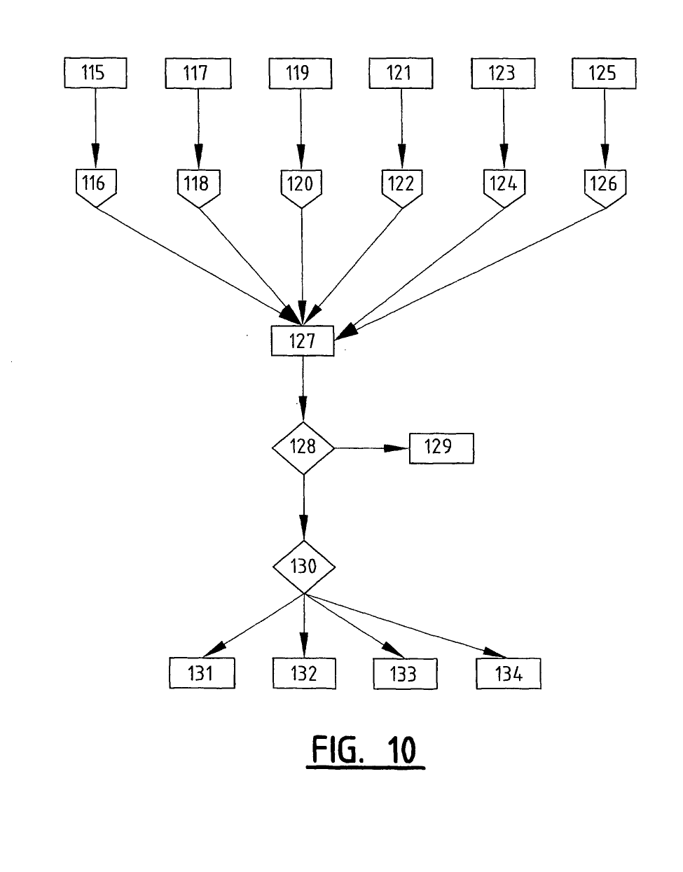

FIG. 8-10 show flow diagrams of further embodiments according to the present invention.

A first embodiment (FIG. 1) comprises a camera 2, illuminating means 3, actuator means 4 and a processing computer 6 which is placed in a protective housing 5. Actuator means 4 serve for making an image recording at the correct moment by means of camera 2. The illuminating means provide illumination of the bottle from the top and/or bottom. In this embodiment the illuminating means are embodied as light-emitting means in the form of for instance a prism or a semicircular cylindrical lens which is connected to a number of light-supplying glass fibre bundles. This embodiment makes it possible to provide a number of adjacent light sources with light by means of one centrally placed light source. The maintenance of such lighting is hereby simple.

The bottles are transported past the lighting and the camera by means of a conveyor 7 (shown schematically). Bottles B are situated in a random orientation relative to the camera. In this embodiment a recording is made by the camera which covers ⅙ of the periphery of the bottle.

In the image processing computer 6 this recording is processed such that an image is obtained as if the periphery of the bottle had been rolled out. For this purpose the image information is stretched to some extent towards both sides of the image recording relative to the image information in the centre of the recording. The thus obtained flat representation is compared to a stored reference image or robust reference image. The method for obtaining this robust reference image is discussed in greater detail hereinbelow. A robust reference image comprises data relating to a plurality of images of bottles. Another manner of describing the robust reference image is that it comprises data relating to one graphic representation of a periphery of a bottle, together with data concerning maximum desired deviations from this ideal reference image. These permitted deviations are related to the desired degree of rejection and the desired quality of the images on the periphery of the container.

In this embodiment the comparing takes place on the basis of creating a differential image, by subtracting the reference image from the flat representation of the recorded image of the bottle for testing. The result of this subtraction is a so-called first differential image D. Using data relating to the mean differential image correction E, a second differential image F is then calculated on the basis of the first differential image D minus the mean differential image correction E.

A top view of the embodiment of FIG. 1 is shown schematically in FIG. 2. Bottles B on conveyor belt 7 have a pitch distance of the diameter of one bottle. This is important for determining the position of assessed bottles. After the recording of the side walls of the bottles has been made, the rejected bottles are ejected from the conveyor belt. A practical method of ejecting the correct bottle is by knowing the number of transport positions of the bottles between recording of the image and the ejection, and by ejecting the correct bottle on the basis thereof.

FIG. 2 further shows schematically a protective cover 9 which screens the bottle at the position of the camera from unpredictable ambient light influences. It is possible here to envisage shadows of passing staff or variations in daylight or other light effects.

A further embodiment according to the present invention is shown in FIG. 3. Two cameras 2 are herein situated on either side of conveyor belt 7. In this embodiment illuminating means 3 are also situated at the position of the cameras. Since it is possible in this embodiment to make two recordings along two sides of a bottle, the selection of the bottle can be carried out on the basis of twice the amount of data. Where in the first embodiment the selection is carried out on the basis of one image of 60° of the periphery, it is possible in this embodiment to carry out the selection on the basis of 120° of the periphery of the bottle. The chance of bottles being approved erroneously is hereby halved relative to the preceding embodiment.

In a further embodiment (FIG. 4) a maximum of seven recordings are made of a bottle, and the bottle is rotated about its central axis during this period. The bottles are fed in the direction of arrow A over a conveyor belt 9. At the position of the cameras, the bottles are urged toward a second conveyor belt by means of guide belt 8. The bottles are then discharged on the right-hand side in the direction of arrow A. During this process the bottles are illuminated from the underside by illuminating elements 3, which are similar to the illuminating elements 3 of the embodiments of FIGS. 1-3. Cameras 2 make recordings of the passing bottles. Guide means 8 are arranged at an angle to conveyor belt 9. A bottle is hereby pressed against guide means 8 during the whole of the transport from left to right. The friction between the bottle and guide means 8 brings about rotation of the bottle. The rotation can be influenced by adjusting the relative speed of guide means 8 and the bottle. For this purpose the guide means 8 are embodied as a conveyor which moves in the direction of arrow F.

In this embodiment the resolution of the camera is 640 by 480 pixels. Depending on the desired selection quality, the image quality can be increased to for instance 600 by 800, 1024 by 768 or for instance 1280 by 960 pixels. The resolution of 640 by 480 pixels enables rejection of the bottle on the basis of defects of 2 by 2 mm in the exterior of the bottle. If higher camera resolutions are used, it becomes possible to reject smaller deviations. The desirability hereof depends for instance on the cost of rejecting bottles.

Making a recording of the bottle is preferably further actuated by means of a sensor which measures the arrival of the bottle at the position of the neck. The embodiment is further at least suitable for the so-called longneck (XLN) bottle. However, through the above stated use of profiles, an unlimited number of different bottles can be detected using this embodiment.

For operation by means of a computer of the above described system, a screen display (FIG. 5) of a computer program is shown. At the top are situated several control buttons 27 and on the right-hand side several input fields 28. The large image display area at bottom left provides a rolled-out, complete peripheral view of a bottle 22, several 60° recordings 24, 25, 26 and an image recording 23.

In a further embodiment (FIG. 6) crates C are assessed as to their exterior. For this purpose recordings are made beneath screening covers 37 of the side walls of the crate. Recordings are made of both the long sides and the short sides of the crate. The image data of the crate is transmitted from the camera to a processing computer 36 which is placed adjacently of the wall in a robust housing 35.

An embodiment of the inspection method is further described hereinbelow on the basis of the inspection of a crate. In step 51 (FIG. 7) an image recording is made of a side wall of a crate. The recorded image 52 is used to determine the type of crate in step 53. Data relating to the crate type 54 is used in step 55 to select the settings of the assessment program. This data, the so-called crate profile, or crate role 57, is used in step 56 together with the recorded image to determine the correct part of the crate periphery for the comparison between the recorded image and a reference image. In step 63 the data relating to the image of the crate is compared to the mean reference image 62. Data 64 relating to shift, rotation, shrinkage and/or other geometric deformation of the image are inserted in a transformation vector 66. In step 67 the image is deformed into a reference image. The result is aligned image 79. In step 81 the difference is measured between this aligned image and a cut-out image 93 to be further described. The resulting current differential image 82 is compensated in step 83 on the basis of the mean differential image 87. The result hereof is the compensated differential image 84 which is exported in step 88.

In step 60 an image mask 61 is further produced. In step 68 the shrinkage is extracted from transformation vector 66, which results in shrinkage data 80. This shrinkage data is exported in 85 and 86. On the basis of the shrinkage data and image mask 61, the image mask is compensated for shrinkage 80 in step 69, which results in a compensated label mask 72.

Image data 59 of crate and handgrip further resulting from step 56 are subjected to a positioning measurement in step 65, which results in data relating to a horizontal and/or vertical shift and/or rotation relative to camera 70. This data 70 is exported in 71. This data 70 is further used in the compensating in 69. The compensated image mask 72 is compared to a blanking mask 76. This blanking mask 76 is the reference mask of the label. The resulting arrangement position data of a label on a crate 74 is used in 75 together with transformation vector 66 and the horizontal shift relative to camera 70 to calculate the blanking position 92. This data 92 is exported in 93. In step 89 a reference label is cut out on the basis of the mean reference image 62 and blanking mask (is reference mask) 76, in order to produce reference cut-out label 93.

The operation of the inspection of the crate colour and crate handgrip is explained with reference to the method of FIG. 8. Data 91 and data 71 are added to step 100 together with data 86.

In step 100 image data is compensated for shrinkage and horizontal shifting, which results in a stretched crate and handgrip image 101. In step 102 profile data is selected for the crate and handgrip. In step 105 profile data 104 is used together with data relating to the reference profile of crate 108 in order to measure a colour difference. Colour difference data 106 is exported in 107. Profile data relating to the handgrip resulting from step 102 is segmented to the handgrip in step 109. Handgrip image data 110 resulting from step 109 is processed in step 111 by means of a differential measurement on the basis of reference data 112 of the handgrip. Differential image data 113 relating to the handgrip is exported in 114.

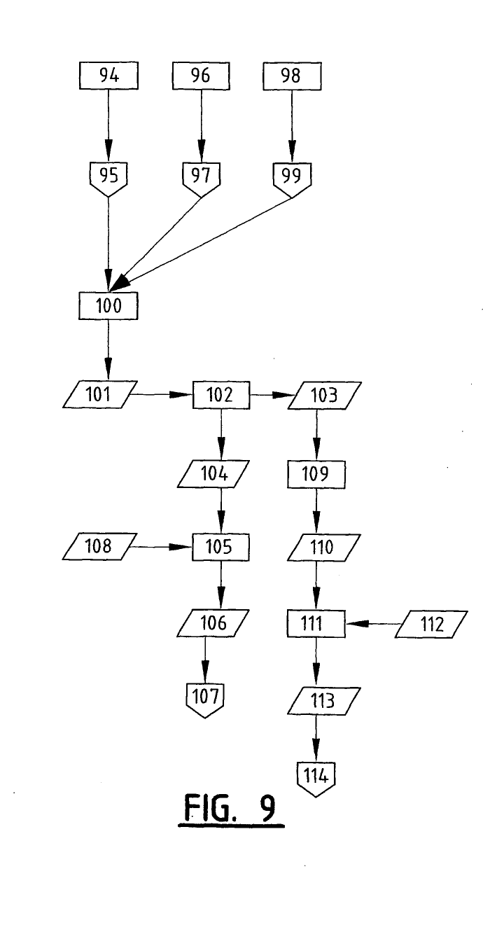

The validation of crate and label is described with reference to FIG. 9. Data 88, 85, 86, 93, 107 and 114 are inspected in step 127. In step 128 is determined whether the crate is approved. In the case that the crate is not approved, this is shown in step 129. If the crate is approved in step 128, it is determined in step 130 whether the reference data must be updated. A reason herefor is that a deviation relative to the mean reference images is for instance found which does not justify rejection. Such data is then included in the reference images, or reference data in steps 131-134. In step 131 the mean differential image is modified. In step 132 the reference image is modified. In step 133 the crate profile is modified and in step 134 the handgrip profile is modified.

The present invention is not limited to the above described preferred embodiment thereof, the rights sought being rather defined by the following claims, within the scope of which many modifications can be envisaged.

1. Method for composing a statistically derived reference image or reference image with permissible deviation values of the exterior of a series of partly substantially cylindrical practically identical containers, comprising steps for:
making an image recording of a part of the exterior of a plurality of containers from the series,
processing the recorded image in order to obtain a first, flat representation,
composing a complete peripheral view of the exterior of the container on the basis of several first representations,
determining, on the basis of all recorded images and parameters to be preset, a robust reference image of the container on the basis of which acceptable differences can be taken into account during selection of containers.

2. Method as claimed in claim 1, further comprising steps for applying statistical analysis methods in determining the robust reference image.

3. Method for selecting a container, comprising steps for detecting deviations on the exterior of the container, comprising steps for:
making an image recording of a part of the exterior,
processing the recorded image in order to obtain a second representation,
comparing the second representation to a robust reference image.

4. Method as claimed in claim 1, wherein the processing of the recorded image comprises steps for transforming an aspect view of a curved surface into a faithful flat rendition.

5. Method as claimed in claim 1 further comprising detecting deviations on the exterior of the container, comprising steps for:
making an image recording of a part of the exterior,
processing the recorded image in order to obtain a second representation comparing the second representation to a robust reference image, and
further comprising using the second representation to compose the robust reference image.

6. Method as claimed in claim 1, wherein the parameters comprise data relating to the container, threshold values relating to colour differences or formats of printing and the like.

7. Method for composing profiles comprising obtaining data from performing the method of claim 1 for the purpose of carrying out selections on mutually alternating series of containers matching respective profiles.

8. Method as claimed in claim 1, further comprising steps for illuminating the container while making the recording.

9. Method as claimed in claim 1, wherein the container is a bottle.

10. Method as claimed in claim 9, wherein the bottle is a glass bottle.

11. Method as claimed in claim 9, wherein the bottle is a beer bottle.

12. Method as claimed in claim 11, wherein the beer bottle has a long neck.

13. Method as claimed in claim 1, wherein the processing speed is higher than ten containers per second.

14. Apparatus for selecting partly substantially cylindrical containers, comprising:
a recording device for making at least one recording of part of a side of the container directed toward the recording device,
a processor for processing a recorded image in order to obtain a first or a second flat representation,
a transmitter for transmitting recording data to the processor,
a comparing device for comparing the second representation to a robust reference image obtained on the basis of parameters to be preset and data from first or second representatons.

15. Apparatus as claimed in claim 14, further comprising a composing device for composing, on the basis of at least one of first and second representations and predetermined parameters, a robust reference image or the reference image with permissible deviation values, such that on the basis of the image at least one of acceptable and natural differences between individual containers within a series of containers can be taken into account during selection of containers.

16. Apparatus as claimed in claim 14, further comprising an ejector for ejecting selected containers.

17. Apparatus as claimed in claim 14, further comprising an illuminating device for illuminating the container while making the recording.

18. Apparatus as claimed in claim 14, further comprising a screen for screening the containers from ambient light influences while making the recording.

19. Apparatus as claimed in claim 14, further comprising an actuator for actuating the making of a recording when a container is correctly positioned relative to the recording device.

20. Apparatus as claimed in claim 14, wherein the recording device comprises at least one camera.

21. Apparatus as claimed in claim 20, wherein a respective one of the cameras is disposed on at least two sides of the container.

22. Apparatus as claimed in claim 14, further comprising a rotating device for rotating the container between operations of the recording device to make two successive recordings.

23. Apparatus as claimed in claim 22, wherein the rotating device comprises a displacing device for lateral displacement of the container, and a friction applying device for causing rotation when the container is pressed against the friction means by the lateral displacement device.

24. Apparatus as claimed in claim 23, wherein the friction applying device comprises a conveyor belt.

25. Apparatus as claimed in claim 14, further comprising a carrousel on which the containers are transported.

26. Apparatus as claimed in claim 14, further comprising a transport device for transporting containers and one or more cameras disposed in stationary manner relative to the transport by the transport device for the containers.

27. Apparatus as claimed in claim 17, further comprising a screen for screening the containers from ambient light influences while making the recording.

28. Method as claimed in claim 3, further comprising steps for illuminating the container while making the recording.

29. Method as claimed in claim 1, wherein the processing speed is higher than sixteen containers per second.
